(19) United States
(12) Patent Application Publication
(10) Pub. No.: US 2026/0363228 A1
(43) Pub. Date: Nov. 19, 2026

(54) FOLDABLE TRAP DRAG

(71) Applicant: Dennis M. Johnson, Kalispell, MT (US)

(72) Inventor: Dennis M. Johnson, Kalispell, MT (US)

(21) Appl. No.: 19/673,895

(22) Filed: May 11, 2026

Related U.S. Application Data
(60) Provisional application No. 63/806,000, filed on May 15, 2025.

(51) Int. Cl. A01M 23/24

(52) U.S. Cl. CPC A01M 23/245

(57) ABSTRACT

A Foldable Trap Drag is described, which is comprised of an elongated body, wherein a first end is comprised of a means to connect a chain, which is connected to the trap to be used. A second end is comprised of an opposing pair of hinged arms, which can be folded to substantially align with the elongated body for compact storage and safe transport into the field. Each opposing arm is slightly canted in the opposite direction of the other arm to facilitate compatibility during storage and to increase ground friction during deployment. The inner border of each opposing arm is further comprised of a plurality of teeth, which aid in the drag catching on ground cover, brush, and/or trees. Each arm is further designed with a novel notch and key mechanism to increase the rigidity of the device in the deployed position. Each arm is further designed to accept a locking band to keep the device in the deployed position, once the trap set is completed.

### CROSS REFERENCE TO RELATED APPLICATIONS

This is a U.S. Nonprovisional Application, which claims priority from U.S. Provisional Application No. 63/806,000 filed May 15, 2025, the disclosure of which is hereby incorporated by reference in its entirety to provide continuity of disclosure.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

The invention described herein relates to the field of animal trapping. The herein described invention is a novel trap drag, which is foldable for storage and safe transport into the field and easy deployment during use. The novel design of the herein described trap drag provides enhanced brush grabbing capability and novel construction for significant force resistance and durability.

In the field of animal trapping, a trap is traditionally anchored by a length of chain to a fixed object such as a rock, tree, or stake pounded into the ground by a trapper. However, utilizing a fixed object to secure a trap has multiple disadvantages. First, a suitable fixed object may not be present where the trapper would like to place the trap. Second, utilizing a stake requires hauling stakes and a mallet into the field, along with other trapping equipment. This limits the amount of other equipment the trapper can haul into the field. Furthermore, in some terrains, such as rocky terrain, it is not possible to pound a stake into the ground to sufficiently anchor the trap. Third, if an animal is trapped by a fixed anchor set, the animal will be confined to that area and will disturb the surrounding vegetation of the area.

To remedy the above issues, trap drags have been utilized to provide an anchor, which can be drug for some distance away from the trap set point. Such trap drags in the prior art are generally composed of solid construction treble style hooks or grapples, which catch on the ground, brush, or trees after the trapped animal has exhausted itself. Other trap drag designs rely on weight and friction with the ground to exhaust the animal. While these trap drag designs provide some advantages over the traditional fixed anchor trap set, they continue to exhibit disadvantages in use. First, the solid construction treble style grapple hook designs are very difficult to transport due to their treble hook design. Sharp points of each hook can easily tear through a pack and injure the trapper while hauling into the field, or while removing them from a pack to deploy. Such designs take up a significant amount of space due to the solid construction of the treble-style hooks, which again, minimizes the amount of equipment that can be hauled into the field. Second, trap drags, which rely on weight for ground friction are inherently heavy, and again, limit the amount of equipment that can be hauled into the field.

Due to the limitations of fixed anchor trap sets and trap drags in the prior art, there remains a need for an improved trap drag system, which is compact for hauling into the field, relatively lightweight, safe for use, and effective as a trap drag.

### BRIEF SUMMARY OF THE INVENTION

Due to the problems identified above, a need exists for the Foldable Trap Drag described herein. The Foldable Trap Drag is comprised of an elongated body, wherein a first end is comprised of a means to connect a chain, which is connected to the trap to be used. A second end is comprised of an opposing pair of hinged arms, which can be folded to substantially align with the elongated body for compact storage and safe transport into the field. Each opposing arm is slightly canted in the opposite direction of the other arm to facilitate compatibility during storage and to increase ground friction during deployment. The inner border of each opposing arm is further comprised of a plurality of teeth, which aid in the drag catching on ground cover, brush, and/or trees. Each arm is further designed with a novel stop lock mechanism to increase the rigidity of the device in the deployed position. Each arm is further designed to accept a locking band to keep the device in the deployed position, once the trap set is completed.

The Foldable Trap Drag described herein solves the problems identified above with traditional fixed anchoring and trap drags described in the prior art. The Foldable Trap Drag can be folded to minimize space during storage and transport into the field. When the Foldable Trap Drag is in the folded configuration, sharp points are folded inward, thus reducing the potential for tearing through packs, or injury of the user during hauling and deployment. The Foldable Trap Drag design minimizes weight and space, thus not limiting the amount of other equipment the user must haul into the field. Furthermore, the notch and key design of the Foldable Trap Drag increases the device's rigidity and tension resistance. As such, the Foldable Trap Drag described herein is a useful and novel invention for the industry.

### BRIEF DESCRIPTION OF THE DRAWINGS

FIG. 1 is a perspective view of the Foldable Trap Drag configured in the

deployed position.

FIG. 2 is a perspective view of the Foldable Trap Drag configured in the folded position.

FIG. 3 is a horizontal plane view of the Foldable Trap Drag in the deployed position.

FIG. 4 is a horizontal plane view of the Foldable Trap Drag in the folded position.

FIG. 5 is a close-up perspective view of the second end of the Foldable Trap Drag showing the stop lock mechanism of each opposing arm in the deployed position.

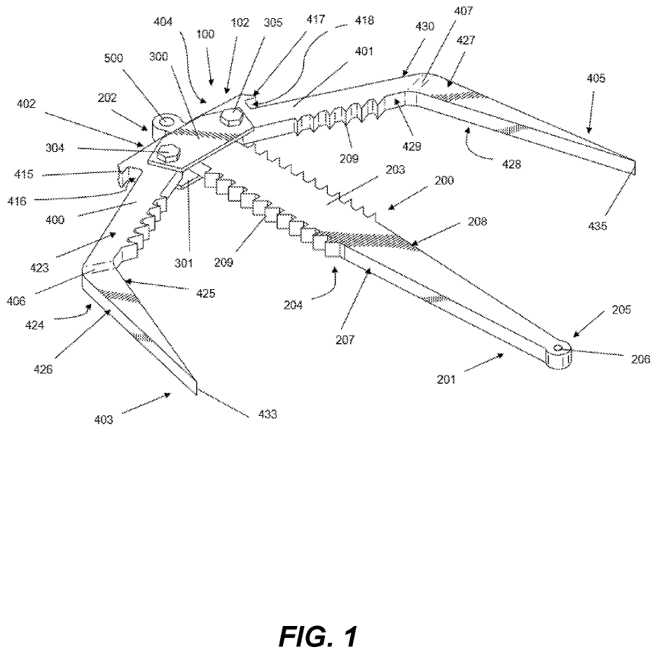

### DETAILED DESCRIPTION OF THE INVENTION

Although only some embodiments of the invention are explained in detail, the figures and explanations should be understood as illustrations only and are not intended to limit the invention in its scope. Also, in describing the embodiments, specific terminology may be used, but it should be understood that specific terms include all technical equivalents that operate in similar manners to accomplish similar purposes.

With reference to the drawings, the preferred embodiment of the subject Foldable Trap Drag 100 is described in detail below. The Foldable Trap Drag 100 is comprised of an elongated body 200, which is comprised of a first attachment end 201, a second arm articulation end 202, a top surface 203, and a bottom surface 204. Said first attachment end 201 is comprised of an attachment means 205 for attaching the Foldable Trap Drag 100 to a length of chain or other material capable of resisting tensile load to a trap. In the preferred embodiment, said attachment means 205 comprises a hole 206 drilled through the elongated body 200 from said top surface 203 to said bottom surface 204. Said elongated body 200 is further comprised of a first lateral side 207 and a second lateral side 208. Each lateral side 207, 208 is further comprised of a plurality of teeth 209, which are cut into said elongated body 200, which function to grab onto and provide purchase of ground cover, brush, or tree during device deployment. Said second arm articulation end 202 is further comprised of a tether hole 500 at its terminus to function as an alternative anchor point.

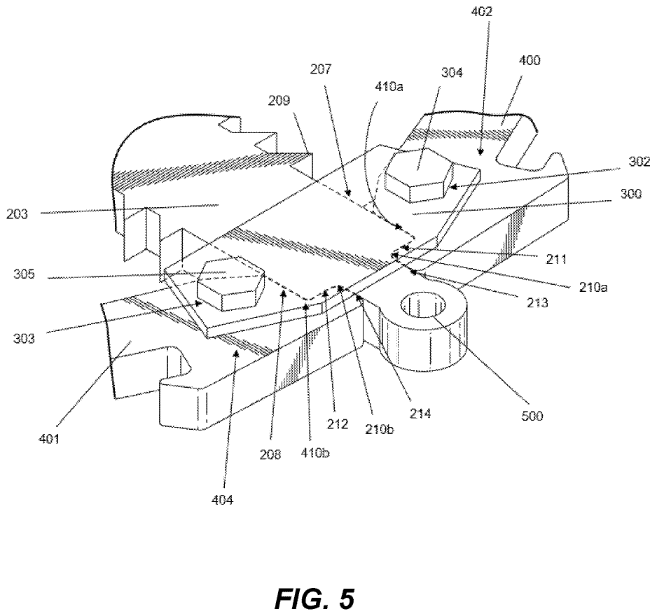

As shown in FIG. 5, distal of said plurality of teeth 209, said second arm articulation end 202 is comprised of a first arm articulation notch 210a, and an opposing symmetrical second arm articulation notch 210b, which are comprised of a first inward 90 degree cutout 211 in said first lateral side 207 and a symmetrical second inward 90 degree cutout 212 in said second lateral side 208. Said first arm articulation notch 210a, is further comprised of first longitudinal 90 degree cut out 213 of said first lateral side 207 and a second longitudinal 90 degree cut out 214 of said second arm second lateral side 208. Said articulation notches 210a, 210b function to provide a solid stop point for deployment of the device drag arms when in use.

Said Foldable Trap Drag 100 is further comprised of a top pivot plate 300 disposed near the distal end of said second arm articulation end 202, top surface 203 and a bottom pivot plate 301 disposed near the distal end of said second arm articulation end 202, bottom surface 204. Said top and bottom pivot plates 300, 301 are generally symmetrical. Said top and bottom pivot plates 300, 301 are further comprised of matching first lateral side 207 pivot holes 302 and second lateral side 208 pivot holes 303, which accept a first pivot bolt 304 and a second pivot bolt 305. The purpose of said top and bottom pivot plates 300, 301 is to provide a securement point of a first side drag arm 400 and a second side drag arm 401 to said second arm articulation end 202 of said elongated body 200. Furthermore, said top and bottom pivot plates 300, 301 with pivot holes 302, 303 provide a pivot point, which allows said first and second drag arms 400, 401 to articulate between a folded 101 and deployed 102 configuration of said Foldable Trap Drag 100.

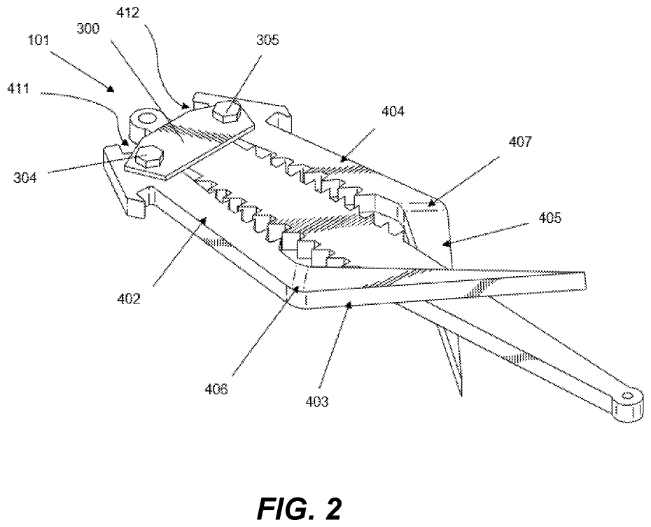

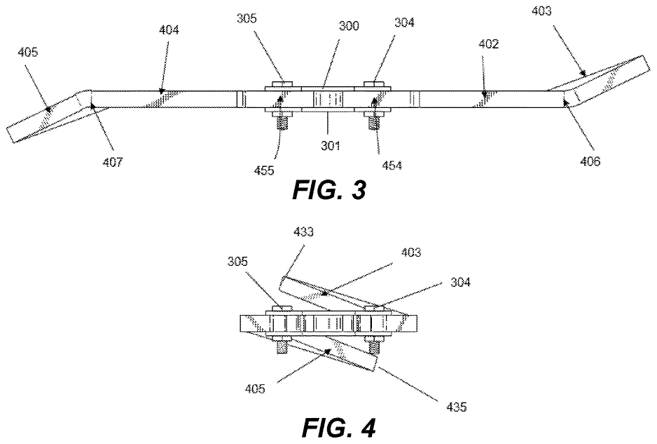

Said Foldable Trap Drag 100 is further comprised of said first side drag arm 400 and said second side drag arm 401. Said first side drag arm 400 is comprised of a first side proximal articulating portion 402 and a first side distal end 403. Said second side drag arm 401 is comprised of a second side proximal articulating portion 404 and a second side distal end 405. Said first side proximal articulating portion 402 is further comprised of a first side proximal articulating portion bolt hole 454 and said second side proximal articulating portion is comprised of a second side articulating portion bolt hole 455, wherein said bolt holes accept pivot bolts 304, 305 to connect said drag arms 400, 401 to said elongated body 203 and create a pivot point for the articulating folding and deployment of the device. Said proximal articulating portions 402, 404 are joined to said distal ends 403, 405 by a first deflection 406 and a second deflection 407 respectively. Said deflections 406, 407 function to provide angular changes in the shape of said trap drag arms 400, 401. Said first drag arm 400 is comprised of an approximate 120 degree inward angle between said first side proximal articulating portion 402 and a first side distal end 403 at said deflection 406. Furthermore, said first distal end 403 is canted upward at said deflection 406 approximately 10 degrees in relation to the horizontal plane of said first side articulating portion 402. Said second drag arm 401 is comprised of an approximate 120 degree inward angle between said second side proximal articulating portion 404 and said second side distal end 405 at said deflection 407. Furthermore, said second distal end 405 is canted downward at said deflection 407 approximately 10 degrees in relation to the horizontal plane of second side articulating portion 404. The opposite 10 degree canting at said deflections 406, 407 of said distal ends 403, 405 in the horizontal plane provides increased ground friction while the device is in the deployed configuration 102 as shown in FIG. 3 and allows for more compact folding of the device in the folded configuration 101 as shown in FIGS. 2 and 4 by allowing said distal ends to overlap each other.

Said trap drag arms are generally the same thickness of said elongated body 203. Said first side drag arm 400 is further comprised of a top surface 423 a bottom surface 424, an inner side 425 and an outer side 426. Said second side drag arm 401 is further comprised of a top surface 427 a bottom surface 428, an inner side 429 and an outer side 430. In the preferred embodiment, said inner sides 425, 429 are further comprised of a plurality of teeth 209, which are cut into said inner sides, which function to grab onto and provide purchase of ground cover, brush, or tree during device deployment. To further enhance the device's effectiveness, said distal ends 403, 405 are comprised of a first point 433 and a second point 435 respectively disposed at the most distal end of said distal ends 403, 405. Said points 433, 435 are capable of catching trees or wedging between small brush stalks or rocks to arrest an animal's movement from the trap site.

Said first and second proximal articulating ends 402, 404 are comprised of a first arm articulation key 410a, and an opposing symmetrical second arm articulation key 410b, which are comprised of a first cutout 411 of said first proximal articulating end 402 and a symmetrical second cutout 412 in said second proximal articulating end 404. Said first arm articulation key 410a, and opposing symmetrical second arm articulation key 410b, are designed to provide a matching key-like articulation with said first arm articulation notch 210a, and opposing symmetrical second arm articulation notch 210b to provide a rigid stop point when said drag arms 400 and 401 are in the deployed position 102.

Said first trap drag arm 400 proximal end 402 is further comprised of an outward extending first locking pin 415 and first band holder notch 416. Said second trap drag arm 401 proximal end 404 is further comprised of an outward extending second locking pin 417 and second band holder notch 418. Said locking pins, 415, 417 and band holder notches 416, 418 function to provide attachment points for a locking pin or band, which when installed retains and locks the device in the deployed position during use.

It is understood that the foregoing examples are merely illustrative of the present invention. Certain modifications of the articles and/or methods may be made and still achieve the objectives of the invention. Such modifications are contemplated as within the scope of the claimed invention.

What is claimed is:

1. A Foldable Trap Drag comprising:
an elongated body, which is comprised of a first attachment end, a second arm articulation end, a top surface, and a bottom surface, wherein said first attachment end is comprised of an attachment means for attaching the Foldable Trap Drag to a length of material capable of resisting tensile load; wherein
said second arm articulation end is comprised of a first arm articulation notch and an opposing symmetrical second arm articulation notch, which are comprised of a first inward 90 degree cutout in said first lateral side and a symmetrical second inward 90 degree cutout in said second lateral side, where said first arm articulation notch is further comprised of a first longitudinal 90 degree cut out of said first lateral side and a second longitudinal 90 degree cut out of said second arm second lateral side;
a top pivot plate disposed near the distal end of said second arm articulation end top surface and a bottom pivot plate disposed near the distal end of said second arm articulation end bottom surface, wherein said top and bottom pivot plates are further comprised of matching first lateral side pivot holes and second lateral side pivot holes, which accept a first pivot bolt and a second pivot bolt;
a first side drag arm and said second side drag arm, wherein said first side drag arm is comprised of a first side proximal articulating portion and a first side distal end and said second side drag arm is comprised of a second side proximal articulating portion and a second side distal end, wherein said first side proximal articulating portion is further comprised of a first side proximal articulating portion bolt hole and said second side proximal articulating portion is comprised of a second side articulating portion bolt hole, wherein said bolt holes accept said pivot bolts to connect said drag arms to said elongated body and create a pivot point for the articulating folding and deployment of the device, and wherein said proximal articulating portions are joined to said distal ends by a first deflection and a second deflection, wherein said first drag arm is comprised of an approximate 120 degree inward angle between said first side proximal articulating portion and a first side distal end at said deflection and said first distal end is canted upward at said deflection approximately 10 degrees in relation to the horizontal plane of said first side articulating portion and said second drag arm is comprised of an approximate 120 degree inward angle between said second side proximal articulating portion and said second side distal end at said deflection and said second distal end is canted downward at said deflection approximately 10 degrees in relation to the horizontal plane of second side articulating portion; and wherein
said first and second proximal articulating ends are comprised of a first arm articulation key, and an opposing symmetrical second arm articulation key, which provide a matching key-like articulation with said first arm articulation notch and opposing symmetrical second arm articulation notch to provide a rigid stop point when said drag arms are in a deployed position.

2. The Foldable Trap Drag of claim 1 wherein said attachment means is comprised of a hole drilled through said elongated from said top surface to said bottom surface.

3. The Foldable Trap Drag of claim 1 wherein said elongated body is further comprised of a first lateral side and a second lateral side where each lateral side is further comprised of a plurality of teeth which are cut into said elongated body.

4. The Foldable Trap Drag of claim 1 wherein said second arm articulation end is further comprised of a tether hole at its terminus to function as an alternative anchor point.

5. The Foldable Trap Drag of claim 1 wherein said first distal end canted upward deflection and said second distal end canted downward deflection allows for said distal ends to overlap each other in a folded configuration.

6. The Foldable Trap Drag of claim 1 wherein said first side drag arm and said second side drag arm are each comprised of an inner side, which are further comprised of a plurality of teeth cut into said inner sides.

7. The Foldable Trap Drag of claim 1 wherein said first side drag arm is comprised of a distal end comprising a first point and said second side drag arm is comprised of a distal end comprising a second point.

8. The Foldable Trap Drag of claim 1 wherein said first arm articulation key is comprised of a first cutout of said first proximal articulating end and said opposing symmetrical second arm articulation key is comprised of a symmetrical second cutout in said second proximal articulating end, wherein said first cutout articulates with said first arm articulation notch and said second cutout articulates with said second arm articulation notch in said deployed position.

9. The Foldable Trap Drag of claim 1 wherein said first trap drag arm proximal end is further comprised of an outward extending first locking pin and said second trap drag arm proximal end is further comprised of an outward extending second locking pin.

10. The Foldable Trap Drag of claim 1 wherein said first trap drag arm proximal end is further comprised of a first band holder notch and said second trap drag arm proximal end is further comprised of a second band holder notch.
